(19) United States
(12) Patent Application Publication
(10) Pub. No.: US 2024/0195074 A1
(43) Pub. Date: Jun. 13, 2024

(54) Antenna system and associated decoupling device

(71) Applicant: THALES, Meudon (FR)

(72) Inventors: Stéphane MALLEGOL, BREST (FR); Nicolas CHEVAL, BREST (FR)

(21) Appl. No.: 18/530,181

(22) Filed: Dec. 5, 2023

(30) Foreign Application Priority Data
Dec. 7, 2022 (FR) 2212895

(51) Int. Cl. H01Q 11/10; H01Q 13/02

(52) U.S. Cl. CPC H01Q 11/10; H01Q 13/02

(57) ABSTRACT

An antenna system including at least one elementary antenna, a metallic plane provided around the elementary antenna, and a decoupling device arranged on the metallic plane, the decoupling device being of the three-dimensional electromagnetic absorption structure type constituted of a plurality of cells arranged in an array, each cell includes, stacked according to a direction normal to the metal plane, a base surmounted by a raised wall, the antenna system being characterized in that the raised wall is shaped so as to form a recessed pattern for trapping electromagnetic waves.

### CROSS-REFERENCE TO RELATED APPLICATIONS

This application is a U.S. non-provisional application claiming the benefit of French Application No. 22 12895, filed on Dec. 7, 2022, which is incorporated herein by reference in its entirety.

### TECHNICAL FIELD OF THE INVENTION

The present invention concerns antenna systems, and more particularly, antenna systems equipped with an electromagnetic—EM decoupling device between an elementary antenna and its close environment.

### BACKGROUND OF THE INVENTION

An antenna system includes one or more antenna assemblies, each antenna assembly in turn including one or more elementary antennas.

When transmitting or receiving, an antenna assembly is electromagnetically coupled with its environment, as for example, with another antenna assembly within the antenna or with the metal plane forming the antenna ground plane.

Two types of coupling may occur:
conducted coupling, which can be quantified by means of S-parameters or distribution parameters at access points (for example, connectors); and
radiated near-field/far-field coupling.

These couplings can be amplified by the physical proximity between antenna assemblies, by their electromagnetic proximity (for example, presence of a common radome), by physical and/or electromagnetic discontinuities (for example, edge effects of the metallic plane), and so on.

These couplings generate undesirable effects such as:
a rise in the phenomenon of standing wave ratio—active SWR, which corresponds to the combination of the SWR of a given antenna assembly and the couplings of this antenna assembly with the other antenna assemblies of the antenna (SWR being defined as the modulus of the reflection coefficient of the antenna assembly). This leads to a possible alteration in the characteristics of the RF radio frequency chains (generation of instabilities, ripples, etc.), particularly on the transmission side;
an alteration of the quality of the complex radiation pattern in the far field. More specifically, pronounced undulatory effects are likely to appear at the level of the main lobe of the radiation pattern of the elementary antenna under consideration, with the following possible impacts: a degradation of the positioning of the main radiation lobe; an alteration of the amplitude and phase of the radiated gain: stronger frequency dependence with possible destructive dips, as well as strong angular variation of gain patterns in a given observation plane; an alteration of the angular aperture of the main lobe at −3 dB, in the main polarization of the antenna under consideration; a rise in the level of gain radiated in reverse polarization; this rise may or may not be localized in frequency and degrading of the polarization purity; and
a desensitization effect on the reception chain of an antenna operating in reception mode by a nearby antenna operating simultaneously in transmission mode.

It is known to provide a decoupling device between or around an antenna assembly.

According to a first approach, the metal plane is corrugated in order to trap electromagnetic waves on its surface.

Typically, the geometry of the corrugations is based on that of quarter-wave resonators: the depth of the corrugations is about λ/4; the width (W) of the corrugations and the gap (g) between two successive corrugations satisfy the constraint:

W+g<λ/2
where A is the wavelength corresponding to the desired operating frequency of the elementary antenna.

This solution is therefore effective for decoupling antenna assemblies at a given frequency or in its immediate vicinity. However, it presents the following disadvantages:
it operates over a reduced frequency band around the resonant frequency (relative bandwidth of the 15% to 20% class), and outside this bandwidth, the coupling-related defects remain present;
the thickness of the metal plane must be greater than the depth of the corrugations, and the spacing between the antenna assemblies must be sufficient to be able to position a sufficient number of corrugations to be effective. However, this is sometimes difficult in view of carrier integration constraints;
for high operating frequencies, the antenna response is sensitive to the precision of the mechanical machining of the corrugations; and
for reasons of mechanical strength (pressure, for example), the corrugations may also need to be filled with dielectric foam (or another material (magneto-dielectric)), or with the material making up the radome in the absence of dielectric foam (for example, when the radome is in direct contact with the ground plane). In this case, additional machining constraints arise, with the associated production costs.

According to a second approach, an electromagnetic (EM) absorber is added to the metal plane.

This can be a volumetric material, for example, based on a magnetic material-resin composite, or a carbon-filled porous dielectric foam. This solution may present the advantage of being highly efficient in reducing the coupling between antenna assemblies, over a wide incidence range. However, it presents the following disadvantages:
for industrial applications, these materials are commercial products. There is no degree of freedom (internal constituents of the absorber, loading ratio, etc.) to match the properties of the EM absorber to requirements;
the material must present a sufficient thickness for high decoupling efficiency. Typically, the required absorber thickness should be greater than or equal to a quarter of the wavelength in the EM absorber, at the minimum operating frequency. This results in a very thick EM absorber, which is contrary to the constraints of carrier integration, where compact thickness is required;
the electromagnetic characteristics (complex relative permittivity and permeability, in particular) of these EM absorbers are, usually, not fully controlled due to their production method, and pronounced inhomogeneities frequently exist between batches of EM absorbers, or even within the same batch of EM absorbers. This militates against reproducible system performance;
the EM absorber must be protected from the external environment by a compatible radome. But, a radome contributes to the coupling, the attenuation of which is sought after. It also degrades the desired compactness in thickness; and
low pressure resistance (particularly for flexible materials) and high mass due to high density (for example, typically greater than or equal to 200 kg/m3 for carbon-impregnated dielectric foams) are penalizing factors.

Instead of a bulk material, a 3D structured EM absorber can be used, such as the one presented in the article X. Lleshi, T. Q. Van Hoang, B. Loiseaux and D. Lippens, “Design and Full Characterization of a 3-D-Printed Hyperbolic Pyramidal Wideband Microwave Absorber,” in IEEE Antennas and Wireless Propagation Letters, vol. 20, no. 1, pp. 28-32, January 2021, doi: 10.1109/LAWP.2020.3037718.

It is obtained by periodization of unit cells. A cell consists of a pyramidal stack of metal/dielectric layers. An EM absorber can be used in X and Ku bands, with absorptivity at normal incidence greater than 0.95 over 8.2-17.2 GHz (absorptivity degrades with incidence).

Such a structure is particularly difficult to manufacture, since it requires double metal-dielectric printing. The manufacturing dispersions impact the RF performance of the absorber all the more as the operating frequency will be higher.

The article by Ren J et al., “3D-Printed Low-Cost Dielectric-Resonator-Based Ultra-Broadband Microwave Absorber Using Carbon-Loaded Acrylonitrile Butadiene Styrene Polymer”, Materials (Basel), 2018 Jul. 20, 11(7), 1249, also describes a 3D structured EM absorber obtained by periodization of single cells. Each cell is constituted of a baseplate topped by a solid cylindrical stud.

Such a structure is easier to produce than the previous one, but the frequency range over which absorptivity is high is reduced.

Furthermore, document CN 114 421 181 A describes a construction material able to absorb ambient electromagnetic waves. This material consists of a flat electromagnetic wave absorption plate and a plurality of electromagnetic wave absorption units forming a pattern. Each unit presents at least one cavity, open at the top and delimited laterally by a wall.

Also known are US 2017/0365931 A1, which discloses high-impedance surfaces, and U.S. Pat. No. 7,408,500 B2, which discloses a radar antenna for motor vehicles.

### SUMMARY OF THE INVENTION

The aim of the present invention is to solve these problems by proposing an alternative 3D structured EM absorber type decoupling device having increased efficiency over a wider frequency band.

To this end, the invention has as its object an antenna system according to the appended claims.

### BRIEF DESCRIPTION OF THE DRAWINGS

The invention and its advantages will be better understood on reading the following detailed description of one particular embodiment, given only as a non-limiting example, this description being made with reference to the appended drawings in which:

FIG. 1 shows a top view and axial section of a first embodiment of an antenna;

FIG. 2 is a perspective view of the antenna decoupling device shown in FIG. 1;

FIG. 3 shows different alternative cell shapes of a decoupling device;

FIG. 4 shows, in top view and axial section, a second embodiment of an antenna;

FIG. 5 shows the gains as a function of bearing of an antenna according to the state of the art and an antenna according to the second embodiment, for two different frequencies in the frequency range; and

FIG. 6 shows, in perspective, the antenna decoupling device according to the invention.

### DETAILED DESCRIPTION

The object of the invention relates to an improved electromagnetic—EM—decoupling device, arranged between one or more antenna assemblies of an antenna system, allowing to overcome the above-mentioned shortcomings, by eliminating, or at least greatly reducing, conducted and/or radiated coupling.

The decoupling device is composed of an electromagnetic absorber structured three-dimensionally in such a manner as to form a recessed pattern able to absorb the EM waves at any angle of incidence.

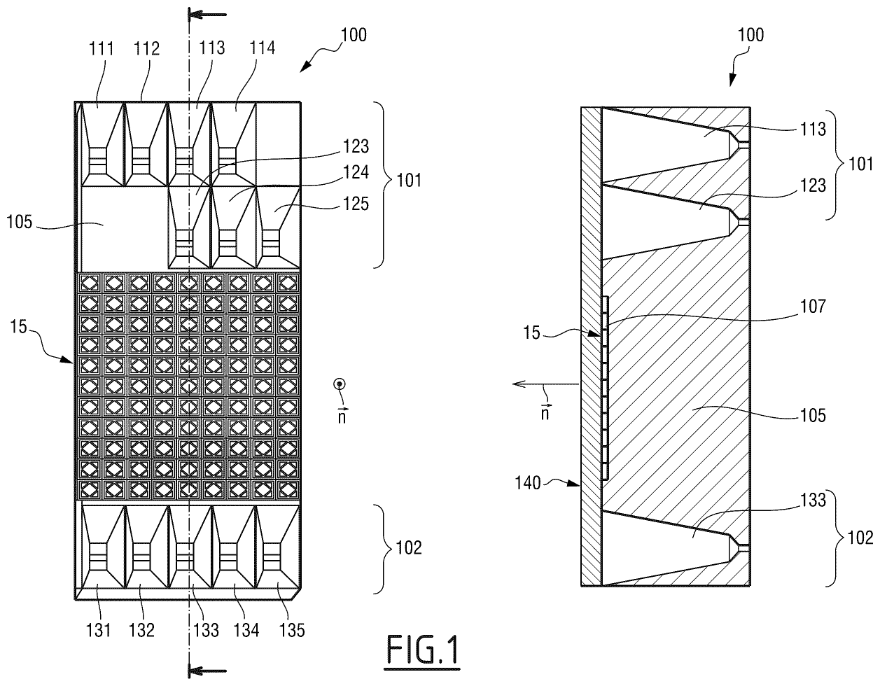

FIG. 1 shows, in general terms, a first embodiment of an antenna system.

In this embodiment, an antenna system 100 includes a plurality of elementary antennas. Each elementary antenna is a horn antenna. Alternatively, each elementary antenna is an antenna of another type, such as a Vivaldi antenna or a wideband planar antenna (spiral, sinuous, log-periodic, etc.).

The horn of each elementary antenna is made in the thickness of a metal plane 105 forming the ground plane of antenna 100.

In the embodiment shown, the elementary antennas are arranged according to three rows. They are respectively designated 111, 112, 113 and 114 for the first row, 123, 124 and 125 for the second row, and 131, 132, 133, 134 and 135 for the third row.

The elementary antenna of the first and second rows form a first antenna assembly 101, and the elementary antenna of the third row form a second antenna assembly 102.

Antenna system 100 includes a decoupling device 15, which in this embodiment is positioned, between the first and second antenna assemblies, on a front face of the metal plane 105, this front face being oriented toward the transmit/receive half-space of the antenna (that is, according to the normal direction \vec{n}).

The function of the decoupling device is to attenuate the main coupling, which in this first embodiment, is the coupling between the first and second antenna assemblies.

Decoupling device 15 is preferably arranged so as to be positioned substantially flush with the plane of the horn apertures.

Decoupling device 15 includes a three-dimensionally structured electromagnetic absorber (“3D EM absorber” in the following).

Advantageously, for protection against external aggression, antenna system 100 includes one or more radome(s).

In FIG. 1, this is a radome 140 common to the various antenna elements, covering the entire front face of metal plane 105, not only the various antenna assemblies 101 and 102, but also decoupling device 15.

Alternatively, only part of the front face of the metal plane is protected by one or more radomes, for example, one radome covering each antenna assembly. In this case, the decoupling device is exposed to the environment.

Advantageously, as shown in FIG. 1, the front face of the metal plane 105 is provided with a recess 107 suitable for the decoupling device 15, the depth of the recess being substantially equal to the height of the decoupling device.

Alternatively, the decoupling device is integrated into the common radome. It is then supported by a rear face of the radome intended to face the front face of the metal plane.

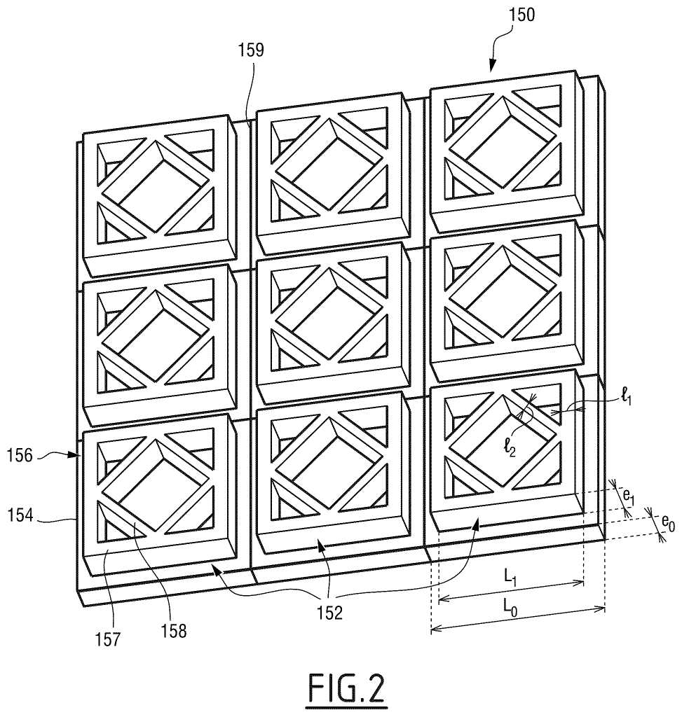

FIG. 2 shows a possible embodiment of the decoupling device of the antenna system shown in FIG. 1. This embodiment is not part of the invention.

A decoupling device 150 includes a plurality of cells 152 forming an array.

For example, a cell is parallelepiped in shape, preferably rectangular. The cells are spatially reproduced in such a way as to constitute an array network of rows and lines of cells.

Each cell comprises a base 154 and, on this base, a raised wall 156 shaped according to a recessed pattern.

Mechanically, a base 154 serves as a support for a raised wall 156, and the various bases allow the decoupling device to be mounted on the metal plane, for example by gluing, screwing or other means.

Electromagnetically, a base plate is advantageously made of an EM-absorbing material, to reinforce the overall effect of the absorption device.

The patterns formed by the raised walls of the various cells are preferably identical.

In the embodiment shown in FIG. 2, raised wall 156 includes an outer frame 157, the sides of which are arranged parallel to the edges of the 154, and an inner frame 158, which is rotated by 45° relative to outer frame 157 and interlocked inside outer frame 157.

The thicknesses of the outer and inner frames may be similar or different.

In the present document, the numerical values are given in order to better understand the invention. However, these values ultimately depend in fine the intrinsic electromagnetic properties of the material actually used to make the electromagnetic absorber.

The characteristic dimensions of a cell are, for example, as follows: the length L₀ of one side of the square base is approximately 0.5λ₀, with λ₀ the wavelength in vacuum for the minimum frequency at which the absorptivity of the EM absorber is greater than or equal to 0.9; the thickness e₀ of the baseplate is approximately 0.01λ₀ (this is a degree of freedom for increasing absorptivity, but too great a baseplate thickness will eventually reduce the absorptivity, as it tends toward a solid-pattern cell); the length L₁ of the raised wall is slightly shorter than that of the base (L₁≈0.425λ₀); the thickness e₁ of the raised wall is approximately 0.1λ₀ (given that the absorber is dimensioned to be flush with the upper surface of the radiating element when positioned around it); the width l₁ of the wall of the square outer frame is approximately 0.0425λ₀; and the width l₂ of the wall of the square inner frame is approximately 0.0275λ₀.

The base and raised wall of a cell allow the EM waves to be absorbed. In particular, the interlocking of several frames (two or more) allows absorption to be improved, in particular by trapping the EM waves, and this, to first order, whatever the plane of incidence and the angle of incidence in this plane of incidence (evaluated relative to the normal direction \vec{n}) (there is in fact a degradation of absorptivity with incidence).

This effect is mainly related to the multiple absorptions of the EM wave (and its possible multiple reflections) interacting with the different walls, depending on its angle of incidence relative to the normal to the metal plane.

In addition, various tests have shown that this shape allows the frequency band over which effective absorption occurs to be broadened.

The materials used for the EM 3D absorber may be thermoplastics with additives, preferably with suitably selected electrical properties, in particular electrostatic dissipative thermoplastics (ESD), such as ABS ESD, PEEK ESD, PEKK ESD, PEI ESD, PLA ESD, . . . . These are ESDs with special properties. They are thermoplastics sufficiently loaded with carbon to generate high dielectric resistivity, but not so loaded with carbon as to become conductive. In the present invention, it is this high resistivity, and therefore the corresponding dielectric losses, which is exploited. These thermoplastics often present in wire form for 3D printing.

Alternatively, dielectric or magneto-dielectric materials may be used.

To structure the 3D EM absorber, it is also possible to combine different materials, such as an interlocking pattern of ESD thermoplastic and a base with magnetodielectric material.

The decoupling device can be manufactured directly by 3D printing, in particular by co-printing two materials when producing a decoupling device integrated into a radome. In the latter case, for example, a thermoplastic is used for the radome and an ESD thermoplastic for the 3D EM absorber.

The metal plane (or the radome) is machined in such a manner as to provide a recess 107 for receiving decoupling device 150. To assemble this, the EM 3D absorber is for example, glued to the bottom of this recess. Creating a recess in the metal plane further allows the thickness of the antenna system to be reduced, as well as its mass.

For environmental constraints (pressure, humidity, etc.), the recessed parts of the EM 3D absorber are advantageously filled with a complementary material. For example, it is possible to use an ESD thermoplastic for the EM absorption function and a compatible thermoplastic to secure the environmental performance. Examples of compatible thermoplastics may include ABS, PLA and PA.

The complementary material being lightweight, this addition presents the advantage of not significantly increasing the mass of the decoupling device, while offering an additional degree of freedom for tuning the absorptivity depending on the working frequency, as well as improving the EM wave trapping effect within the 3D EM absorber.

The dimensioning of the cells (in particular the shape of the patterns, the dimensions of the patterns in the three directions, the thickness of the base and the distance between cells) is advantageously optimized by 3D EM simulation with, as a convergence criterion, an absorptivity A, preferably greater than or equal to 0.9 in the desired working frequency band (A=1−|S11|², with |S11| the simulated reflectivity at a given reference plane), which corresponds to a reflectivity less than or equal to −10 dB.

In the embodiment shown in FIG. 2 (pattern constituted of two square frames at 45° to each other), it is possible to first of all, pre-dimension the sides of the frames knowing the effective electromagnetic properties of the constituent material, and then optimize the dimensions of the 3D EM absorber to obtain the desired absorptivity.

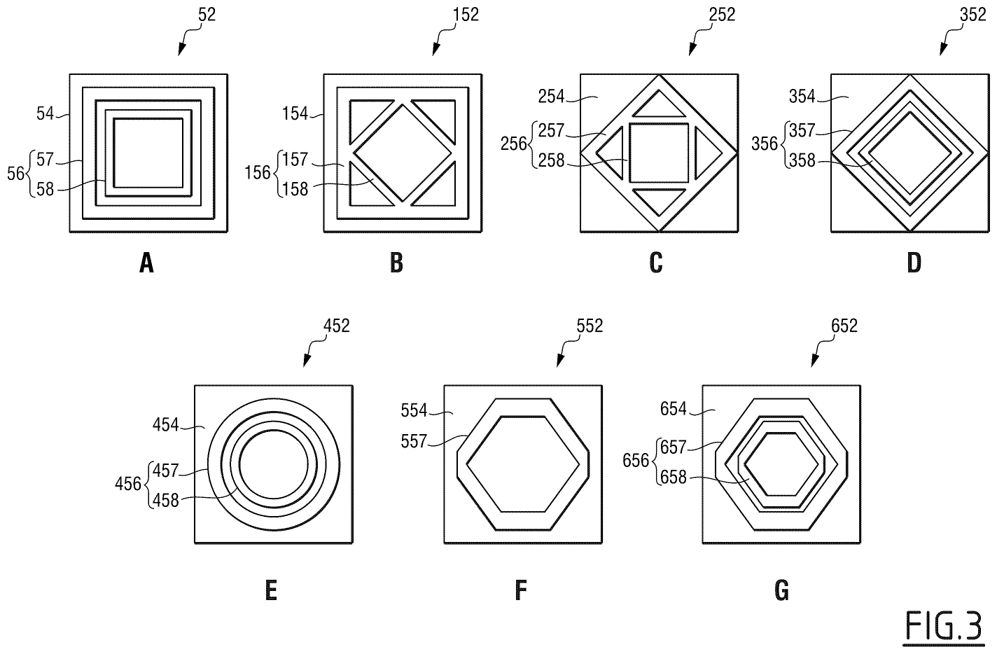

FIG. 3 shows a number of different alternative embodiments for decoupling an antenna system. These different embodiments differ only in the shape of the cell pattern of the 3D EM absorber. These different embodiments are not part of the invention.

In FIG. 3A, a cell 52 includes a base 54 and a raised wall 56. The latter is composed of a square-shaped outer frame 57, the sides of which are parallel to the edges of the base, and an inner frame 58, also square, received inside the outer frame, and the sides of which are parallel to the edges of the base.

In FIG. 3B, a cell 152 includes a base 154 and a raised wall 156. The latter is composed of a square outer frame 157, the sides of which are parallel to the edges of the base, and an inner frame 158, also square, received inside the outer frame, and the sides of which are at a 45° angle relative to the edges of the base. The corners of the inner frame are flush with the outer frame. This is the embodiment shown in FIG. 2.

In FIG. 3C, a cell 252 includes a base 254 and a raised wall 256. The latter is composed of a square outer frame 257, the sides of which are at a 45° angle to the edges of the base, and an inner frame 258, also square, received inside the outer frame, and the sides of which are parallel to the edges of the base.

In FIG. 3D, a cell 352 includes a base 354 and a raised wall 356. The latter is composed of a square outer frame 357, the sides of which are at an angle of 45° to the edges of the base, and an inner frame 258, also square, received inside the outer frame, the sides of which are at an angle of 45° to the edges of the base.

In FIG. 3E, a cell 452 includes a base 454 and a raised wall 456. The latter includes an outer frame 457 in the form of a circular ring, and an inner frame 458 also in the form of a circular ring, received inside the outer frame.

In FIG. 3F, a cell 552 includes a base 554 and a raised wall, which includes a single frame 557, in this case polygonal, in particular hexagonal.

In FIG. 3G, a cell 652 includes a base 654 and a raised wall 656. The latter consists of a hexagonal outer frame 657 and a hexagonal inner frame 658, which is received inside the outer frame and oriented in the same way as the outer frame.

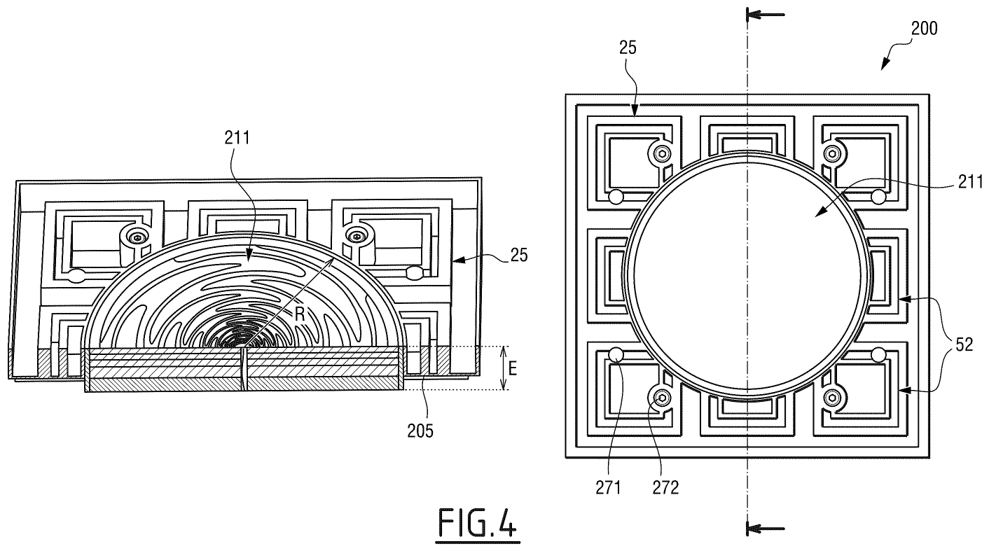

FIG. 4 shows a second embodiment of an antenna system.

In this second embodiment, an antenna system 200 includes an elementary antenna 211, which is, for example, a wideband planar antenna. It is, in this second embodiment, a dual-polarized sinuous antenna, forming a disk of radius R and thickness E, arranged on a metal plane 205 of antenna 200.

Metal plane 205 is a thin plate relative to the thickness of the radiating element.

Antenna system 200 includes a decoupling device 25. It is positioned on metal plane 205 in such a manner as to surround an elementary antenna 211. Advantageously, the front face of the decoupling device is flush with the antenna plane.

It is, for example, fixed on metal plane 205 by means of screws 272 passing through holes 271.

The function of decoupling device 25 is to attenuate the main coupling, which is, in this second embodiment, the coupling between the radiating element and metal plane 205. Indeed, when the antenna assemblies are sufficiently physically separated from each other, the radiated coupling that may exist between them is reduced and the main coupling is that between a given antenna assembly and its close physical environment (metal plane and/or radome). Thus, as an alternative, the antenna system may include a plurality of elementary antennas, but these would be sufficiently distant from one another for the main coupling to be that between an elementary antenna and the metal plane. It could be said that this second embodiment relates to one or more radiating elements isolated from one another.

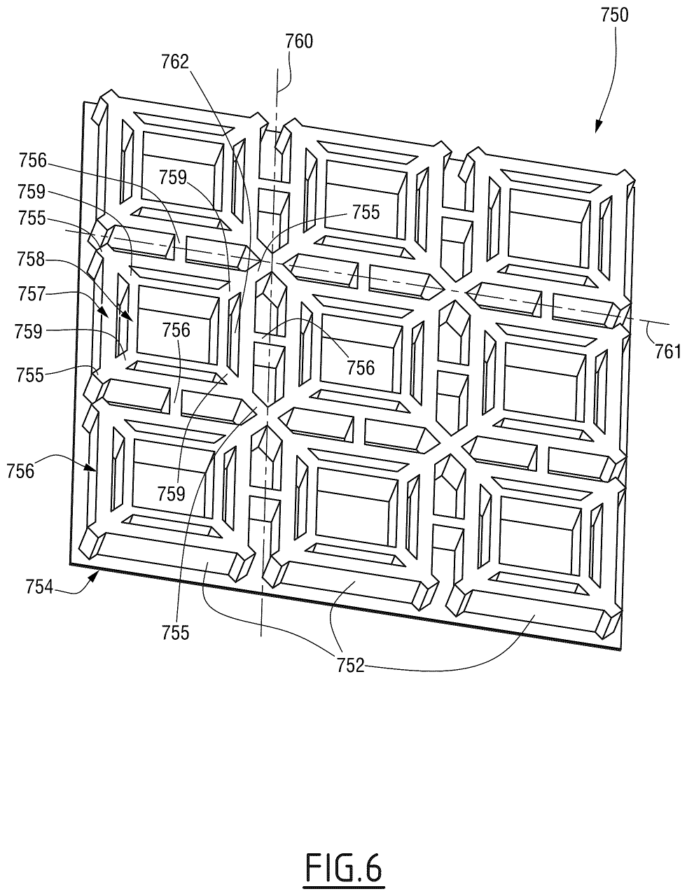

Decoupling device 25 includes a three-dimensional structured electromagnetic absorber with a recessed pattern. For example, decoupling device 25 is structured in accordance with embodiment A of FIG. 3, with the exception of a scaling factor, this scaling factor being a function of the working frequency range provided for operation of the antenna system 200. Alternatively, decoupling device 25 is structured according to another embodiment, any of the embodiments of FIG. 3 or the embodiment of FIG. 6.

Advantageously, for protection against external aggression, antenna system 200 includes one or more radome(s) (not shown in FIG. 4).

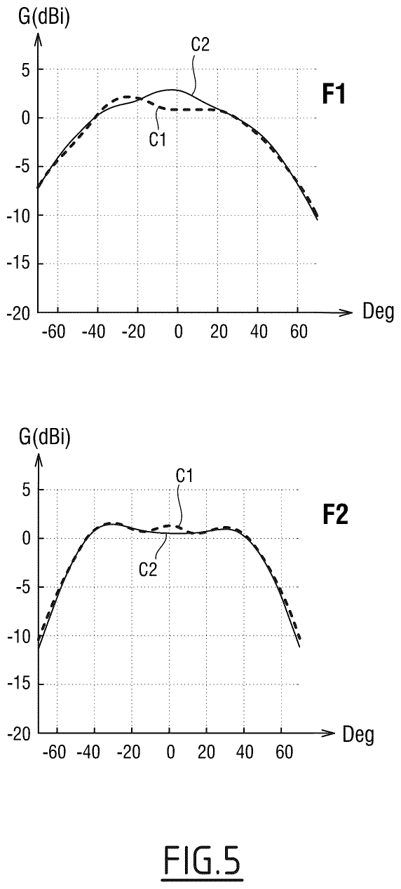

FIG. 5 illustrates the RF response measured on a wide-frequency band antenna assembly, by means of two graphs, each graph giving the gain (expressed in isotropic decibel—dBi) radiated depending on the bearing angle (expressed in degrees—Deg), at zero elevation angle and in main polarization.

On each of these graphs, a curve C1 corresponds to the antenna device of FIG. 1 or to that of FIG. 4 but without a decoupling device, and curve C2 corresponds to the antenna device of FIG. 1 or to that of FIG. 4 with a decoupling device.

For example, the first graph corresponds to a frequency F1 close to the FMIN frequency, and the second graph corresponds to a frequency F2 close to the FMAX frequency.

The FMIN and FMAX frequencies are limits of the useful frequency band of the antenna over which a high absorptivity (for example, greater than 0.9) is obtained.

Those skilled in the art will note an improvement in gain with the implementation of the invention, as well as its stabilization as a function of the bearing angle (elimination of the gain ripple effect).

Furthermore, these tests allow to prove effectiveness of the solution over a wide range of frequencies. Relative to the state of the art presented in the article by Ren J. et al., the useful frequency band of which presents an FMAX/FMIN ratio of 3, the solution proposed herein allows an absorptivity of at least 0.9 over a very wide useful band, typically with an FMAX/FMIN ratio of 10.

FIG. 6 shows an embodiment in accordance with the invention of a decoupling device, whether it is device 15 of the antenna system shown in FIG. 1 or device 25 of the antenna system shown in FIG. 4.

In FIG. 6, a decoupling device 750 is constituted of a plurality of cells 752 forming an array.

For example, a cell is parallelepiped in shape, preferably rectangular. The cells are spatially reproduced in such a manner as to constitute an array of rows and lines of cells.

Each cell includes a base 754 and, on this base, a raised wall 756 shaped according to a recessed pattern.

The patterns formed by the raised walls of the various cells are preferably identical.

In this embodiment, a raised wall 756 is composed of an outer frame 757 and an inner frame 758.

Outer frame 757 is provided, on its periphery, with at least one lug projecting radially toward the exterior of outer frame 757, in other words toward the adjacent cells.

For example, outer frame 757 is square in shape.

Each vertex of outer frame 757 is provided with a corner 755. A corner lug comes into contact with one or more corner lugs carried by the outer frames of the cells adjacent to the cell under consideration.

Alternatively, or in combination, each side of outer frame 757 is provided with a central lug 755. A central lug comes into contact with a central lug carried by the outer frame of the cell adjacent to the cell under consideration, in such a manner as to form a link between these outer frames of neighboring cells.

Alternatively, or in combination with the preceding variants, inner frame 758 is also provided with at least one lug projecting radially toward the exterior of inner frame 758 toward the adjacent frame, in other words, toward outer frame 757 of the cell in question.

For example, in FIG. 6, inner frame 758 is square-shaped.

Each vertex of inner frame 758 is provided with a corner lug 759. A corner lug comes into contact with the outer frame, for example the corner of the outer frame.

Alternatively, or in combination, the inner frame may carry central lugs forming as many connections with the outer frame of the same cell.

The lugs on the various cells allow channels between facing walls to be closed, such as, for example, a channel 760 between two rows of cells, a channel 761 between two lines of cells, or even as a channel 762 between the inner wall of outer frame 757 and the outer wall of inner frame 758 of the same cell.

This allows the electromagnetic waves to be trapped, particularly the creeping waves, which might otherwise propagate along such channels.

In fact, the level of trapping of the creeping waves is improved by increasing the height of the frames above the base. The presence of lugs allows to achieve the same level of trapping, but without increasing the height. In other words, for the same raised wall height, the presence of lugs significantly increases the trapping of the creeping waves.

In this respect, an increase in the thickness of the base would lead to a degradation in reflectivity. The present invention allows a compromise between the desired reflectivity (typically below −10 dB) over a wide frequency band, while trapping creeping waves (between unit cells, at the absorber-metal plane interface).

Thus, the decoupling device according to the invention is particularly effective while remaining thin.

More generally, the desired level of electromagnetic wave trapping for a decoupling device results from a compromise between the size of the lugs (contiguous or not) and the height of the frames of the raised wall.

Alternatively, a gap is provided between a lug and either the adjacent lug(s) or the adjacent frame. The corresponding channel is therefore not blocked (when the lugs are contiguous) but presents a narrowing (when the lugs are not contiguous).

Alternatively, a frame adopts a polygonal shape other than a simple square (for example, a hexagon as in the embodiment of FIG. 3G), the frames are interlocked but with a different orientation (for example, with a 45° rotation, as in the embodiment of FIG. 3C), and/or with different heights.

While the lugs are preferably integral with the raised wall, alternatively, the lugs are added and may therefore not be made from the same material as that forming the absorbent unit cells.

In yet another alternative, a lug presents an absorption gradient. This is obtained, for example, by varying the volume loading of the material used, or even by multi-material printing.

According to the hot spots of the creeping waves (identifiable by calculating the Poynting vector or the electromagnetic energy density at different points), this gradient can be associated with a variation in the thickness and width of the lug.

According to the invention, the decoupling device consists of a three-dimensional structured electromagnetic absorber that is effective over a wide frequency range, compact in thickness, low in mass, and with controlled dispersion, while being passive.

1. An antenna system comprising:
at least one elementary antenna;
a metal plane provided around said at least one elementary antenna; and
a decoupling device arranged on said metal plane, the decoupling device being of a three-dimensional electromagnetic absorption structure comprising a plurality of cells arranged in an array, each cell comprising, stacked along a direction normal to the metal plane:
a base; and
a raised wall on top of said base, wherein the raised wall is shaped to form a recessed pattern for trapping electromagnetic waves, the recessed pattern comprising a plurality of frames interlocked one inside the other, wherein at least one frame of the plurality of frames is provided with at least one lug, the at least one lug extending laterally away from the at least one frame and cooperating with an adjacent frame of the same cell or of an adjacent cell, in order to close, at least partially, a channel between the at least one frame and the adjacent frame.

2. The antenna system according to claim 1, wherein the recessed pattern includes an outer frame and an inner frame, the outer frame having a shape selected from among a square, a rectangle, a ring or a polygon, and the inner frame having a shape selected from a square, a rectangle, a ring or a polygon.

3. The antenna system according to claim 1, wherein: a side of the base is approximately 0.5λ₀, a thickness of the base is approximately 0.01λ₀, an extension, characteristic of the raised wall is approximately 0.425λ₀, a thickness of the raised wall is approximately 0.1λ₀, a width of the raised wall is between 0.0425λ₀ and 0.0275λ₀, where λ₀ is a wavelength in vacuum for a minimum frequency from which an absorptivity of the decoupling device is greater than or equal to 0.9.

4. The antenna system according to claim 1, wherein the material of said base and/or said raised wall is a thermoplastic with additive.

5. The antenna system according to claim 1, wherein the material of said base and/or said raised wall is a statically dissipative thermoplastic.

6. The antenna system according to claim 1, wherein the cells are identical to each other.

7. The antenna system according to claim 1, wherein said decoupling device is arranged between two elementary antennas for attenuation of a coupling between the two elementary antennas, or around one elementary antenna for attenuation of a coupling between the elementary antenna and said metal plane.

8. The antenna system according to claim 1, wherein said metal plane is provided with a recess for receiving said decoupling device.

9. The antenna system according to claim 1, further comprising at least one radome.

10. The antenna system according to claim 8, wherein said decoupling device is integrated into said at least one radome.

11. The antenna system according to claim 1, wherein a recessed portion of one cell of said decoupling device is filled with a material complementary to the material used for said base and said raised wall of the cell.

12. The antenna system according to claim 1, wherein a recessed portion of one cell of said decoupling device is filled with a material complementary to and compatible with the material used for said base and said raised wall of the cell.

13. The antenna system according to claim 1, wherein the elementary antenna is a horn antenna, a Vivaldi antenna, or a wide frequency band planar antenna.

14. The antenna system according to claim 1, wherein the elementary antenna is a spiral, a sinuous, or a log-periodic antenna.
